(19) United States
(12) Patent Application Publication
(10) Pub. No.: US 2008/0072449 A1
(43) Pub. Date: Mar. 27, 2008

(54) Method of Improving Runnability of a Drying Section of a Paper Machine, Use of a Rotating Drying Cylinder, Drying Section of a Paper Machine and Method of Selecting a Drying Strategy

(75) Inventors: Nenad Milosavljevic, Turku (FI); Oleg Timofeev, Jyvaskyla (FI)

Correspondence Address: COHEN, PONTANI, LIEBERMAN & PAVANE, 551 FIFTH AVENUE, SUITE 1210, NEW YORK, NY, 10176, US

(73) Assignee: METSO PAPER, INC., HELSINKI (FI)

(21) Appl. No.: 11/794,258

(22) PCT Filed: Dec. 30, 2005
(86) PCT No.: PCT/FI05/00561

§ 371 Date: Sep. 10, 2007

(30) Foreign Application Priority Data
Dec. 31, 2004 (FI) 20041697

(51) Int. Cl. F26B 3/02; F26B 11/02; F26B 13/00

(52) U.S. Cl. 34/446; 34/108; 34/618

(57) ABSTRACT

This invention relates to a method of improving runnability of a drying section (40) of a paper or board machine or similar. A paper web is contacted with surfaces of a number of successive drying cylinders (41) at a machine speed of at least 550 m/min. One or more drying cylinder surfaces in the beginning of the drying section are heated to a temperature of at least 120° C. The invention also relates to a use of heated rotating drying cylinders in a paper machine or similar, a drying section of a paper machine and a method of selecting a drying strategy.

### TECHNICAL FIELD OF THE INVENTION

This invention relates to a drying section of a paper machine, board machine or similar. This invention relates especially to a method of improving runnability of a drying section of a paper machine and comprising the following steps: transporting a paper web from a press section of the paper machine into a drying section of the paper machine, and bringing the paper web into a contact with surfaces of a number of successive drying cylinders in the drying section, of which cylinders at least some are heated. The invention also relates to use of heated rotating drying cylinders in a paper machine or similar, drying section of a paper machine and method of selecting a drying strategy.

### BACKGROUND ART

In a normal paper or board machine a moving web of paper is formed on a moving fabric or a wire. The paper web is gradually dried when transported through the paper machine, the drying occurring mostly in the drying section of the paper machine.

In a typical paper or board machine the starting material of paper or board, i.e. fibrous pulp is brought in the so-called wet end of the paper machine. The pulp is brought on a moving fabric or wire through a head box and moving web of paper is formed on the moving fabric. Simultaneously begins the removal of water from the moving web. The first section of the paper machine is often called the wire section. In a typical wire section water is removed from the paper web mainly by sucking with vacuum pumps.

After the wire section the paper web is normally transported to a press section. In the press section water is removed mainly mechanically, e.g. by pressing the wet web between water-absorbent felts.

After the press section the paper web is normally transported to a drying section where the drying of the paper web is mainly conducted. Typically in a drying section the paper web is heated and the water is mainly removed from the moving paper web by evaporation. In a typical drying section the paper enters with a dry content of 35-65%.

After the drying section the dried paper web can be transported to e.g. surface treatment or other kind of finishing treatments.

In order to raise the production capacity of a paper machine, there exists a continuing demand to increase the speed of the moving paper web of the paper machine. Today, paper machine speeds of 2000 m/min are a fact and an intensive research is carried out in order to achieve even higher machine speeds.

One of the speed limiting factors in a paper machine is the drying section. A problem in the beginning of the drying section is the sticking or pasting of the paper web on the cylinder surface, i.e. the fibres of the paper web are sticking on the drying cylinder surface. This results in dirty drying cylinder surfaces, which leads to holes in paper, uneven drying, runnability problems etc. In theory pasting is caused by decrease in the melting or softening temperature of lignin and hemicellulose, which are present in the paper as fibre constituents. Lignin and hemicellulose are polymers having an amorphous structure and changing their structure at elevated temperatures in the presence of water. The melting temperature of lignin is the temperature at which the lignin structure starts to change from solid shape to plastic shape due to degradation of polymer chains to single monomers. Melting temperature of lignin depends on the water content of the paper web. The melting temperature of natural dry lignin is around 190° C., while water content of 30-40% in the paper reduces the melting temperature of lignin to 90° C. In the prior art it is suggested that it is necessary to keep the temperature of the drying cylinders below the melting temperature of lignin in the beginning of the drying section, where the paper web is still relatively wet and then gradually increase the cylinder temperature further down in the drying section. During normal paper production the temperatures of the drying cylinders in the beginning of the drying section are typically 60-80° C. Low drying cylinder temperatures result in lower drying capacity of the drying section.

Another of the speed limiting factors in a paper machine is the transition of the paper web from the press section to the drying section. A typical drying section comprises a plurality of heated rotating drying cylinders against which the paper web is brought into contact with. The paper web leaves the press section while being relatively wet. Due to the high adhesion forces between the wet paper web and heated drying cylinders and so-called opening nip forces or vacuum forces, the paper web easily remains attached to or it tends to follow the surface of the rotating drying cylinder in the beginning of the drying section. If the paper web remains attached to or follows the cylinder surface the result is often a paper web break, causing runnability problems in paper production. Normally these problems are tried to be solved e.g. with runnability box devices e.g. blow boxes or vacuum boxes. These runnability box devices are normally arranged to create underpressure in a space between cylinders of a drying section, i.e. in a dryer pocket. Underpressure is created in order to facilitate the detachment of the paper web from the cylinder surface and in order to keep the paper web following the fabric, which supports the paper web.

### SUMMARY OF THE INVENTION

The object of the present invention is to solve or minimise the problems and disadvantages existing in the prior art.

One object of the present invention is to provide a method with which the runnability problems associated with especially the beginning of the drying section of a paper machine, a board machine or similar are reduced.

Another object of the present invention is particularly to provide a drying section of a paper machine, a board machine or similar, providing improved drying capacity and runnability.

Another object of the present invention is to provide a method of selecting a drying strategy in a drying section of paper machine.

In order to realise for instance the objects mentioned above the methods of the invention, the use of the invention and the drying section of a paper machine of the invention are characterised by what is presented in the characterising parts of the enclosed independent claims.

The embodiment examples and advantages mentioned in this text are in suitable parts applicable to both a method and a drying section of a paper machine according to the invention, even if this is not always particularly mentioned.

In this text paper machine can mean different kind of paper machines as well as board machines and other similar machines. The invention is suitable for production of many different paper grades: e.g. fine, newsprint, LWC, SC, board paper and many more—with different basis weights.

A typical method of improving runnability of a drying section of a paper machine according to the present invention comprises the following steps:
transporting a paper web from a press section of the paper machine into a drying section of the paper machine, the paper web being transported at a machine speed of at least 550 m/min
bringing the paper web into contact with surfaces of a number of successive drying cylinders in the drying section, of which cylinders at least some are heated,
heating in the beginning of the drying section at least one drying cylinder surface, with which surface the paper web is brought into a contact, to a temperature of at least 120° C., preferably at least 130° C.

Now it has been surprisingly found out that the runnability problems in the beginning of the drying section originating from the adhesion and/or vacuum forces and/or pasting of the wet paper web to the drying cylinder surfaces can be significantly diminished or even totally overcome by simply heating the surface of at least one drying cylinder in the beginning of the drying section to a temperature of at least 120° C. This high surface temperature of a drying cylinder contributes to the reduction of the adhesion of the paper web to the rotating cylinder surface by minimising the adhesion and/or vacuum forces preventing the separation of the wet paper web from the drying cylinder in an opening nip.

According to the present invention it is assumed that the high surface temperature of a drying cylinder in the beginning of the drying section causes the fibres and the water present in the paper web to be heated so intensively that water becomes superheated and begins to boil in the first side of paper web, which is arranged towards the heated drying cylinder. The superheated boiling water generates steam and thereby provides an overpressure between the drying cylinder surface and the first side of the paper web. In the opening nip the overpressure created by this generated steam “pushes” the paper web outwards from the cylinder surface and thus minimises the vacuum forces existing in the nip. Generated steam also “pushes” the water, which is present in the paper web to the second side of the paper web arranged away from the drying cylinder surface. As the water is being “pushed” away from the first side of the paper web and the pores on the first side of the paper web are filled with steam, the adhesion forces between the paper web and the drying cylinder surface are significantly reduced as the contact area of the water with the cylinder surface is decreased. At the same time also the viscosity of the water is lowered as the temperature of the water is higher. This reduces also the adhesion forces between the first side of the paper web and the drying cylinder surface.

Contrary to the beliefs expressed in the prior art, it was also found out that this radical raise in the cylinder surface temperature did not increase the pasting of the paper web to the cylinder surface. It is assumed, without being bound by a theory, that this is due that the high temperature of the drying cylinder surface “dries out” the first side of the paper web very fast, in practice immediately when the first side comes into contact with the cylinder surface. As the dry content in the first side of the web is higher, the melting temperature of the lignin present in that part of the web becomes higher than the temperature of the cylinder surface, and no or minimal pasting occurs.

The present invention makes it also possible to shorten the length of the drying section, i.e. reduce the number of the drying cylinders that are needed to the drying of the paper web to the given dry content. This can be done as the drying of paper can be done more effectively already in the beginning of the drying section due to the high surface temperatures of the drying cylinders.

In the present text it is understood that the paper web enters the drying section via a first end of the drying section, and the paper web exits the drying section via a second end of the drying section. Further, in the present context the beginning of the drying section is understood as the part of the drying section located at the first end of the drying section, and the length of the beginning of the drying section can be calculated as a number of drying cylinders in the first end of the drying section, which number is typically 50%, preferably 30%, more preferably 20% of the total number of the drying cylinders in the drying section. If the above-mentioned calculation results in a number that is not an integer, the number can be rounded up or down to the nearest whole number.

In an embodiment of the invention the first and/or the second and/or the third drying cylinder surface in the beginning of the drying section are heated to a temperature of at least 120° C. Other cylinders may be situated between the first heated cylinders, e.g. suction cylinders. It is also possible that as very first cylinders there are one or more other cylinders than a high temperature cylinder of the invention.

According to one embodiment of the invention a paper web is transported from a press section into a drying section of the paper machine. Normally at this stage the dry content of the paper web is 35-65%, more typically 38-55%, more typically 38-48%. A typical drying section comprises several successive rotating drying cylinders arranged to be contacted by the web in a predetermined order. Furthermore, typical drying section comprises heating means for heating at lest some of the drying cylinder surfaces and means for controlling the temperature of the heated cylinder surfaces.

According to one embodiment of the present invention the first and/or the second and/or the third drying cylinder surface in the beginning of the drying section is heated to a temperature of at least 150° C. It is possible that not all drying cylinder surfaces are heated to a temperature of at least 150° C. in the beginning of the paper machine. According to one embodiment of the invention every second cylinder surface is heated to a temperature of at least 120° C. or at least 130° C., and every second cylinder surface is heated to a conventional temperature of 60-80° C. It is also possible that only certain percentage of the number of the drying cylinder surfaces in the beginning of the drying section are heated to a temperature of at least 120° C. or 130° C., typically 30%, more typically 40%, preferably 60%, more preferably 70% or even 90% of the total number of the surfaces. Typically 3 to 4 drying cylinder surfaces at the first end of the drying section are heated to a temperature of at least 130° C.

According to another embodiment of the present invention in the beginning of the drying section at least one drying cylinder surface, with which surface the paper web is brought into a contact, is heated to a temperature, which is at least 120° C., 130° C., 140° C., 150° C., 160° C., 170° C., 180° C., 190° C., 200° C., 210° C., 220° C., 230° C., 240° C., 250° C., 260° C., 270° C. or 280° C., and lower than 450° C., typically lower than 400° C., more typically lower than 350° C., more typically lower than 300° C., preferably lower than 250° C., more preferably lower than 200° C. or lower than 180° C. In some embodiments of the invention the high temperature of a drying cylinder can mean any of these above-mentioned temperatures.

The present invention is especially suitable to be used in paper machines having an average speed of at least 2000 m/min, preferably up to 2500 m/min. The drying section of the invention improves the runnability of the paper machine so that the high speeds can be reached and maintained without web breaks. According to some embodiments of the invention, the machine speed is at least 600 m/min, 700 m/min, 800 m/min, 900 m/min, 1000 m/min, 1100 m/min, 1200 m/min, 1300 m/min, 1400 m/min, 1500 m/min, 1600 m/min, 1700 m/min, 1800 m/min, 1900 m/min, 2000 m/min, 2100 m/min, 2200 m/min, 2300 m/min, 2400 m/min, 2500 m/min or 3000 m/min, and lower than 3500 m/min, typically lower than 3000 m/min, more typically lower than 2500 m/min, more typically lower than 2200 m/min, preferably lower than 2000 m/min, sometimes lower than 1800 m/min or lower than 1500 m/min.

According to one embodiment of the invention those drying cylinder surfaces in the beginning of the drying section, with which cylinder surfaces the paper web having a dry content more than 45% is brought into a contact, are heated to a temperature of at least 140° C. It has been found out that in a paper web having a dry content more than 45% the melting temperature of lignin is such that the web can be brought into a contact with a drying cylinder surface having a temperature of at least 140° C. without any extensive pasting problems. Correspondingly, according to another embodiment of the invention those drying cylinder surfaces in the beginning of the drying section, with which cylinder surfaces the paper web having a dry content more than 50% is brought into a contact, are heated to a temperature of at least 120° C. or at least 130° C.

According to one embodiment of the invention the web is brought into a contact with cylinder surfaces heated to a temperature <100° C. after the web's dry content is more than 55%. This enables the possibility that only those cylinder surfaces are heated to temperatures >100° C., which surfaces come into a contact with a paper web having a dry content less than 55%. After obtaining the dry content of 55% it is possible to continue the drying of the web with drying cylinders having a lower surface temperature in order to reach the final dry content of the web. The final dry content depends on the paper grade that is produced.

In a typical so called single felted paper machine configuration the drying section comprises rows of drying cylinders and vacuum rolls. Usually drying cylinders are arranged on the top row and below them are arranged suction rolls, i.e. vac rolls. The paper web is travelling through the drying section in slalom form, approaching at first a first drying cylinder and then a vac roll. According to one embodiment of the invention a number of drying cylinders in the beginning of the drying section are replaced with high temperature drying cylinders, e.g. first drying cylinders up to 4 cylinders are replaced with high temperature cylinders having a surface temperature of more than 120° C. or more than 130° C. After these cylinders a conventional drying section can be used for the drying of the paper web.

In traditional drying section using steam heated drying cylinders same steam pressure is used in a number of cylinders. Cylinders are grouped to form so called steam groups, where the surface temperature of group member cylinders is about the same. For example, a drying section can comprise 5 steam groups, where the first group comprising cylinders 1-10 are fed with 1 bar pressure, second group comprising cylinders 11-20 are fed with 2 bar pressure, third group comprising cylinders 21-30 are fed with 2.5 bar pressure, fourth group comprising cylinders 31-50 are fed with 3 bar pressure and rest of the cylinder forming the fifth group are fed with 3.5 bar pressure. This kind of steam feeding system is called cascade steam condense system.

According to one embodiment of the present invention one to four of the first cylinders in the first group are arranged as drying cylinders having a high surface temperature. The rest of the drying section can be arranged in a traditional way. This means that the temperature of the drying cylinder surfaces and the steam pressure inside the cylinders is gradually increasing in the cylinder groups after the high temperature cylinders.

According to another embodiment of the invention the first one to four cylinders are arranged as cylinders having a high surface temperature. With the high temperature cylinders a safe dry content of the paper web can be reached, i.e. a dry content where paper web is not sticking any more to the cylinder surfaces. This situation is usually reached at approximately 55% dry content. After the high surface temperature heated drying cylinders can be fed with steam with falling pressure. For example, the steam pressure in the first group can be set to be 5.5 bars, in the second group 4.5 bars, in the third group 4 bars, in the fourth group 3.5 bars and in the rest of the drying cylinders 3 bars. This novel system can be called a reverse cascade steam system.

According to still another embodiment of the invention after high temperature cylinders all the heated cylinder surfaces are kept at some substantially constant temperature level, i.e. fed with about the same steam pressure. For example if the drying section comprises 75 heated cylinders, the 4 first cylinders could be high temperature cylinders. After them cylinders from 5 to 65 could be set at a constant pressure level, e.g. 10 bars. Only the last ones could then be fed with a lower pressure, e.g. 3 bar, in order to cool the paper web and to control the quality of the paper.

In other words, according to one embodiment of the invention the drying cylinder surfaces are heated to a temperature of at least 120° C. or at least 130° C. with a heating medium, such as steam, condensed steam or superheated steam, hot air, combustion air or hot oil. Preferably the heating medium is fed into the first drying cylinder having a surface heated to a temperature of at least 120° C. or at least 130° C. If the cylinder is steam heated the steam can be led from the first drying cylinder to second and/or third successive drying cylinders. Thus the pressure and temperature of the steam fed to a drying cylinder are decreasing the further down towards the second end of the drying section the cylinder is located. For example, pressure of the steam, which is fed to the first cylinder, can be e.g. 5.5 bar, from which first cylinder the steam is led to the successive second cylinder, the steam then having a pressure of 5.0 bar. From the second cylinder the steam is fed to the successive third cylinder, the steam then having a pressure of 4.5 bar. From the third cylinder the steam is fed to the successive fourth cylinder, the steam having a pressure of 4.0 bar. It is understood that for heating all cylinder surfaces in the beginning of the drying section steam having substantially the same pressure, e.g. 10 bar, and the same temperature can be used.

The first heated cylinders of the drying section can be relatively easily and thus inexpensively changed to high temperature cylinders in order to realise the present invention. Suitable high temperature drying cylinders that can be used in the present invention can use e.g. combustion air to heat the surface of the cylinder. Inside the cylinder can also be arranged a burner, which is heating the inner surface of the cylinder, and the heat is then transferred through the cylinder wall to the outer surface of the cylinder. Both of these cylinder types as well as e.g. oil heated cylinders are known for a person skilled in the art.

According to a further embodiment of the invention a drying section of a paper machine comprises
a first group of heated rotating drying cylinders each having a heated cylinder surface arranged to be contacted with a paper web in a predetermined order, the first group arranged in the beginning of the drying section, and
a second group of heated rotating drying cylinders each having a heated cylinder surface arranged to be contacted with a paper web in a predetermined order.

The drying section further comprises
a first cylinder heating means arranged to heat at least one of the surfaces of cylinders in the first group, and
a second cylinder heating means arranged to heat the surfaces of cylinders in the second group.

According to this embodiment of the invention the first and second cylinder heating means are separate of each other.

Advantageously the first and second cylinder heating means are separately controllable, thus providing the possibility to select the temperature of the high temperature cylinders, i.e. the first group of heated rotating drying cylinders independently of the temperature of the second group of heated rotating drying cylinders.

According to an embodiment of the invention the high temperature cylinders of the invention have a separate and separately controlled heating system from the rest of the drying section.

According to an embodiment of the invention the drying section comprises one or more, e.g. 1, 2, 3, 4 or 5 high temperature cylinders as the first drying cylinders. After these high temperature cylinders the drying section can be arranged to comprise a reverse cascade steam system, as described above. The heating system of the high temperature cylinders may be arranged separate and different from the heating system of the steam groups of the reverse cascade steam system.

In an embodiment of the invention the second group of heated rotating drying cylinders is arranged to be contacted with the paper web after the first group. This way the separate heating arrangements are easily installed and controlled separately. The first cylinder heating means may comprise means to heat the cylinder surfaces of the first group with a heating medium, such as steam, condensed steam or superheated steam, impingement air, combustion air, oil. With these media heating to the high temperatures is easy.

One embodiment of the invention is a method of selecting a drying strategy in a drying section of a paper machine. This method comprises following steps:
a paper web of a certain grade is contacted on a heating cylinder surface for a certain time,
the paper web of the certain grade is contacted with the heating cylinder surface various times, with various combinations of heating cylinder surface temperatures and dry content of the paper web, the heating cylinder against which the paper web of a certain grade is contacted is advantageously rotatable and rotated during the testing,
information on whether the paper web is sticking on to the heating cylinder surface or not is kept on an electric memory,
a chart for a certain paper grade showing at which paper web dry contents and at which cylinder temperatures the paper web tends to stick on the cylinder is drawn up,
surface temperatures of drying cylinders of a drying section of a paper machine are selected based on the chart in such a way that according to the chart the paper web does not stick to the heated cylinder surfaces.

According to a preferable embodiment the cylinder temperatures in the beginning of the drying section are selected to be higher than the temperatures at which the paper web is sticking to the heating cylinder surface. That is, the beginning of the drying is done with temperatures above the area where sticking is expected.

### BRIEF DESCRIPTION OF THE DRAWINGS

The invention is described by way of examples with reference to accompanying schematical drawings, in which

FIG. 1 shows schematically the forces affecting the wet paper web in the opening nip,

FIG. 2a shows schematically a cylinder surface/paper web/supporting fabric-system according to the prior art, and

FIG. 2b shows schematically a cylinder surface/paper web/supporting fabric-system according to the present invention,

FIG. 3 shows schematically a chart for planning a drying strategy in a drying section according to the present invention,

FIG. 4 shows schematically a drying section according to one embodiment of the invention.

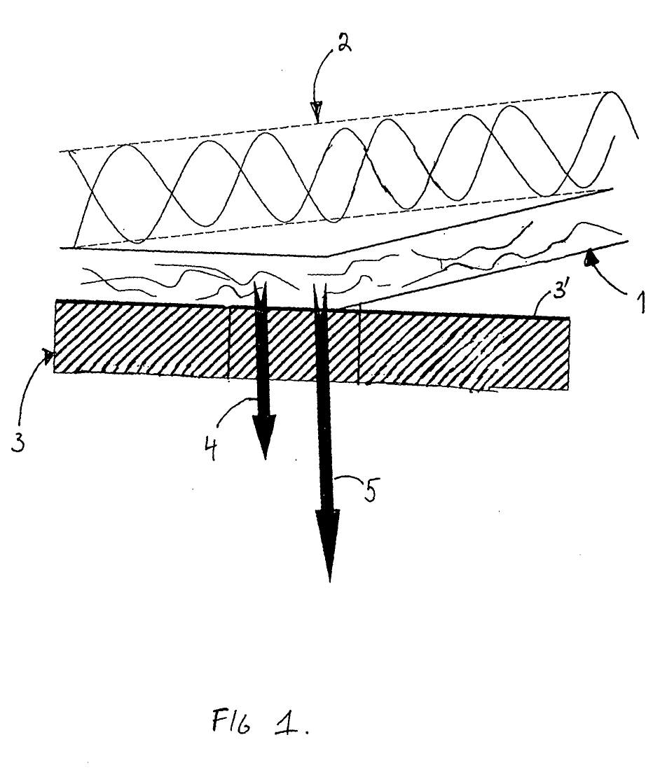

FIG. 1 shows schematically the forces affecting the wet paper web in the opening nip. The wet paper web 1 is transported by a supporting fabric 2 over the surface 3′ of a heated drying cylinder 3. In the opening nip adhesion and vacuum forces, denoted with arrows 4, 5 affect the wet paper web 1 and cause the web 1 to follow the cylinder surface 3′ into the opening nip. For the optimal runnability it is preferable that the web 1 follows the supporting fabric 2. In a system according to the present invention where the cylinder surface in the beginning of the drying section is heated to a high temperature, the adhesion force and the vacuum force between the paper web and the cylinder is reduced significantly.

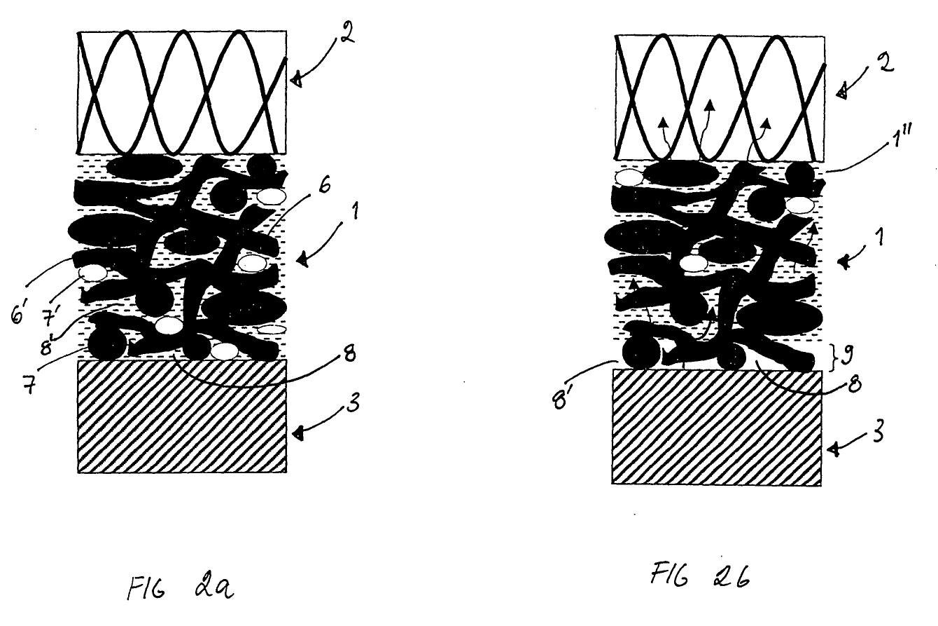

FIG. 2a shows schematically a cylinder surface/paper web/supporting fabric-system according to prior art. The wet paper web 1 is transported by a supporting fabric 2 over a drying cylinder 3, which is heated to a temperature of 60-80° C. Paper web comprises fibres 6, 6′ and different additive particles 7, 7′ such as retention aids, fillers, stock sizes, etc. Between fibres 6, 6′ and additive particles 7, 7′ exists pores and cavities 8, 8′ that are filled with the water present in the paper web 1. Water wets the fibres 6, 6′ and causes a decrease in the melting temperature of the lignin, which is one of the fibre constituents.

FIG. 2b shows schematically a cylinder surface/paper web/supporting fabric-system according to the present invention. The wet paper web 1 is transported by a supporting fabric 2 over a drying cylinder 3, which is heated to a temperature of at least 150° C. Water present in pores and cavities 8, 8′ on the first side 1′ of the paper web 1, which is in contact with the surface of the heated drying cylinder 3, is converted to steam, denoted with arrows in the FIG. 2b. Consequently a substantially water-free area 9 is created on the first side of the web 1. This reduces the adhesion and vacuum forces between the web 1 and the cylinder 3, as well as minimises the reduction in the melting temperature of lignin. Steam that is formed on the first side of the web 1 “pushes” the water through the web 1 to the second side 1″ of the web 1, which is in contact with the supporting fabric 3. Consequently the adhesion forces between the wet paper web 1 and the supporting fabric are increased thus improving the attachment of the web 1 to the supporting fabric 3.

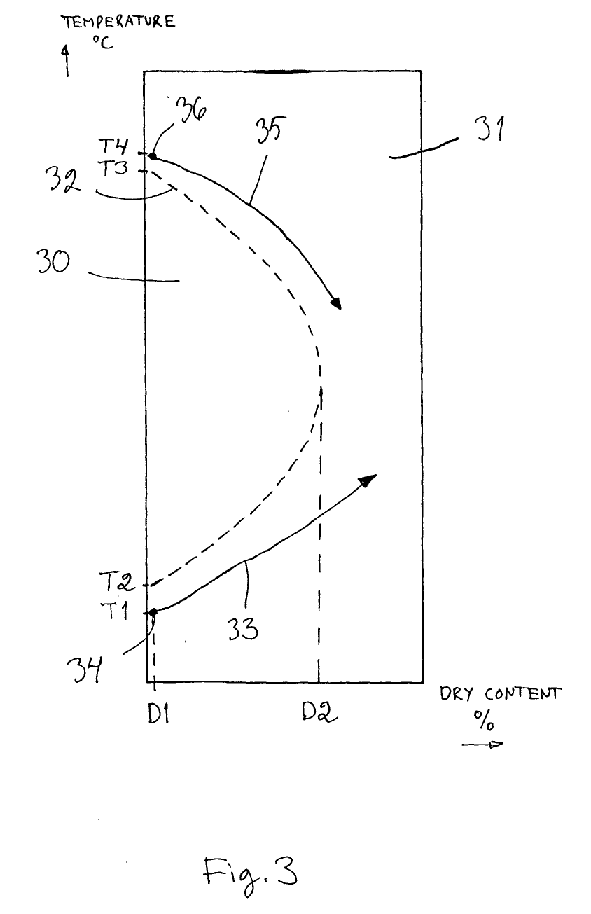

In FIG. 3 is presented a schematic chart for a certain paper grade showing at which paper web dry contents and at which cylinder temperatures the paper web tends to stick on the cylinder. Area 30 shows the combinations of cylinder surface temperature and paper web dry content, which result in sticking. Area 31 shows the combinations of cylinder surface temperature and paper web dry content, which do not result in sticking. The dashed borderline 32 is shown here as a sharp and beautiful, smoothly curved line. In reality though, the border between the two regions 30 and 31 maybe somewhat inexact and may have certain irregularities in its shape.

The chart of FIG. 3 is drawn up with a method where first a paper web of a certain grade is contacted on a heating cylinder surface for a certain time. The paper web of the certain grade is contacted with the heating cylinder surface various times, with various combinations of heating cylinder surface temperatures and dry content of the paper web. E.g. 20 or 30 of such tests usually give an overall picture of the sticking area. Information on whether the paper web is sticking on to the heating cylinder surface or not is saved, preferably on an electric memory, such as a computer hard disk or on other memory device.

The prior art path of the drying strategy in a drying section of a paper machine is depicted in FIG. 3 with an arrow 33. The paper web is brought in to the drying section at start point 34, i.e. its dry content is D1. To avoid sticking the cylinder surface temperature of the first heated cylinder in the drying section is kept at temperature T1, which is lower than the temperature T2 at the border 32. If the first cylinder temperature would be slightly higher than T2, sticking of the paper web on to the first heating cylinder would be expected. After the first heating cylinder the paper web has already dried a little. Thus, the second heating cylinder surface temperature can be a little higher than the first one T1. Anyway, all the time the temperature has to be kept under the borderline 32. Furthermore, due to adhesion and opening nip forces the runnability will be problematic, especially on higher machine speeds, and requires usually effective runnability devices.

The path of the drying strategy according to the invention in a drying section of a paper machine is depicted in FIG. 3 with an arrow 35. The paper web is brought in to the drying section at start point 36, i.e. its dry content is D1. To avoid sticking the cylinder surface temperature of the first heated cylinder in the drying section is kept at temperature T4, which is higher than the temperature T3 at the border 32. If the first cylinder temperature would be slightly lower than T3, sticking of the paper web on to the first heating cylinder would be expected. After the first heating cylinder the paper web has already dried a little. Thus, the second heating cylinder surface temperature can be a little lower than the first one T1, if wanted.

When the dry content of the paper web rises over the top dry content D2 of the sticking area 30, the surface temperature of the cylinders can be lowered if wanted. E.g. the next cylinders can be conventional steam heated cylinders. With the drying strategy of the invention, due to high cylinder surface temperature in the beginning of the drying section, sticking is avoided, adhesion and opening nip forces are minimised and runnability is improved. Due to decreased adhesion and opening nip forces, less effective runnability devices in the drying pockets are usually enough in order to establish good runnability.

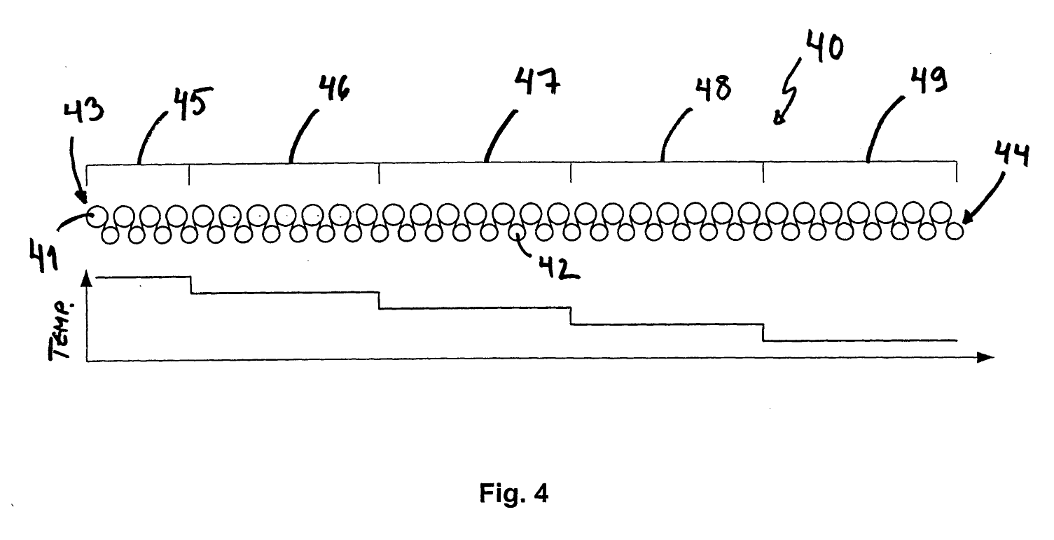

FIG. 4 shows schematically a drying section 40 according to one embodiment of the invention. The drying section comprises a plurality of steam heated drying cylinders 41 and turning rolls 42 between them. Paper web enters the drying section from the first end 43 of the drying section. Paper web is taken out of the drying section from the second end 44 of the drying section. The diagram below the cylinders describes the surface temperature of the steam heated cylinders 41 as a function of their position in the drying section 40. The drying section is divided into 5 steam groups 45-49. Drying cylinders 41 in each steam group have substantially same surface temperature. Surface temperature decreases towards the second end 44.

The first steam group 45 comprises the first four heated cylinders of the drying section. The second, third, fourth and fifth steam groups 46-49 each comprise seven heated cylinders.

The drying cylinders 41 are arranged as a reverse cascade steam system. In other words, the cylinder surfaces of the first cylinder group, i.e. steam group 45 are heated to a high temperature of at least 120° C. This high temperature could be e.g. 130° C., 140° C., 150° C. or 160° C. or higher. This temperature is selected as needed according to process parameters. Preferably fresh steam is fed into the first cylinder group 45. The steam is led from the first cylinder group to second cylinder group 46, from there to third cylinder group 47, from there to fourth cylinder group 48 and from there further to fifth cylinder group 49. Thus, the pressure and temperature of the steam fed into a cylinder are decreasing the further down towards the second end 44 of the drying section the cylinder is located. For example, pressure of the steam, which is fed to the first cylinder group can be e.g. 5.5 bar. Steam fed to the second cylinder group 46 might then have a pressure of 5.0 bar. Steam fed to the third cylinder group 47 might have a pressure of 4.5 bar. Steam fed to the fourth cylinder group 48 might have a pressure of 4.0 bar. Steam fed to the fifth cylinder group 49 might have a pressure of 3.5 bar.

Piping, valves and other equipment needed to conduct steam between cylinder groups is known per se, and thus not explained any further here.

The heating system of the high temperature cylinders may be arranged separate and different from the heating system of the later steam groups arranged as a reverse cascade steam system. E.g. one to four first heated cylinders in the drying section 40 could be heated with steam, condensed steam or superheated steam, hot air, combustion air or hot oil separately from the rest of the drying cylinders. It is also possible to produce a decreasing temperature profile according to FIG. 4 with separate heating systems for each cylinder group 45-49.

While the invention has been shown and described with reference to certain embodiments thereof, these are merely provided to illustrate the invention and should not be construed as limitations of the invention's scope. Thus, it will be understood by those skilled in the art that various modifications in the form and details can be made therein without departing from the spirit and scope of the invention.

1. A method of improving runnability of a drying section (40) of a paper machine, comprising the following steps:
transporting a paper web from a press section of the paper machine into a drying section of the paper machine, with the paper web being transported at a machine speed of at least 550 m/min,
bringing the paper web into a contact with surfaces of a number of successive drying cylinders (41) in the drying section, of which cylinders at least some are heated,
characterised in
heating in the beginning of the drying section (40) at least one drying cylinder surface (41), with which surface the paper web is brought into a contact, to a temperature of at least 120° C.

2. A method according to claim 1, characterised in
heating the first and/or the second and/or the third drying cylinder surface in the beginning of the drying section (40) to a temperature of at least 120° C.

3. A method according to claim 1, characterised in
heating in the beginning of the drying section (40) at least one drying cylinder surface (41), with which surface the paper web is brought into a contact, to a-temperature, which is at least 130° C., 140° C., 150° C., 160° C., 170° C., 180° C., 190° C., 200° C., 210° C., 220° C., 230-C, 240° C., 250-C, 260° C., 270° C. or 280° C., and lower than 450° C., typically lower than 400° C., more typically lower than 350° C., more typically lower than 300° C., preferably lower than 250° C., more preferably lower than 200° C. or lower than 180° C.

4. A method according to claim 1, characterised in that the paper web is transported at the machine speed of at least 600 m/min, 700 m/min, 800 m/min, 900 m/min, 1000 m/min, 1100 m/min, 1200 m/min, 1300 m/min, 1400 m/min, 1500 m/min, 1600 m/min, 1700 m/min, 1800 m/min, 1900 m/min, 2000 m/min, 2100 m/min, 2200 m/min, 2300 m/min, 2400 m/min, 2500 m/min or 3000 m/min, and the paper web is transported at the machine speed of lower than 3500 m/min, typically lower than 3000 m/min, more typically lower than 2500 m/min, more typically lower than 2200 m/min, preferably lower than 2000 m/min, more preferably lower than 1800 m/min or lower than 1500 m/min.

5. A method according to claim 1, characterised in
heating those drying cylinder surfaces in the beginning of the drying section, with which cylinder surfaces the paper web having a dry content less than 45% is brought into a contact, to a temperature of at least 150° C.

6. A method according to claim 1, characterised in
heating those drying cylinder surfaces (41) in the beginning of the drying section, with which cylinder surfaces the paper web having a dry content more than 45% is brought into a contact, to a temperature of at least 140° C.

7. A method according to claim 1, characterised in
heating those drying cylinder surfaces in the beginning of the drying section, with which cylinder surfaces the paper web having a dry content more than 50% is brought into a contact, to a temperature of at least 120° C., preferably at least 130° C.

8. A method according to any of the preceding claims, characterised in
bringing the web into a contact with cylinder surfaces heated to a temperature <100° C. after the web's dry content is more than 55%.

9. A method according to claim 1, characterised in
heating the cylinder surfaces to a temperature of at least 120° C. with a heating medium, such as steam, condensed steam or superheated steam, impingement air, combustion air, oil.

10. A method according to claim 1, characterised in that the drying section (40) comprises steam heated drying cylinders (41) and that the cylinders are grouped to form several steam groups (45-49), each steam group comprising at least one cylinder (41), whereby steam with substantially same pressure is fed in cylinders of one group and surface temperature of cylinders in one group is maintained substantially the same.

11. A method according to claim 10, characterised in that the first steam group (45) comprises cylinders having a high surface temperature of at least 120° C.

12. A method according to claim 11, characterised in that with the first steam group the paper web is dried to a dry content of at least 55%.

13. A method according to claim 11, characterised in that the steam groups (46-49) after the first steam group are fed with steam with decreasing pressure.

14. A method according to claim 11, characterised in that the pressure and temperature of the steam fed into a drying cylinder (41) are decreasing the further down towards the second end (44) of the drying section the cylinder is located.

15. Use of at least one heated rotating drying cylinder having a surface temperature of at least 120° C., preferably at least 130° C., in the beginning of a drying section (40) of a paper machine, which drying section comprises a number of successive rotating drying cylinders (41) each having a surface which is arranged to be contacted with a paper web in a predetermined order.

16. Drying section (40) of a paper machine, which drying section comprises
a first group (45) of heated rotating drying cylinders (41) each having a heated cylinder surface arranged to be contacted with a paper web in a predetermined order, the first group arranged in the beginning of the drying section,
a second group (46) of heated rotating drying cylinders each having a heated cylinder surface arranged to be contacted with a paper web in a predetermined order,
characterised in that the drying section further comprises
a first cylinder heating means arranged to heat at least one of the surfaces of cylinders in the first group,
a second cylinder heating means arranged to heat the surfaces of cylinders in the second group,
wherein the first and second cylinder heating means are separate of each other.

17. A drying section according to claim 11, characterised in that the second group is arranged to be contacted with a paper web after the first group.

18. A drying section according to claim 11, characterised in that the first cylinder heating means comprises means to heat the cylinder surfaces of the first group with a heating medium, such as steam, condensed steam or superheated steam, impingement air, combustion air, oil.

19. A method of selecting a drying strategy in a drying section (40) of a paper machine, which comprises following steps:
a paper web of a certain grade is contacted on a heating cylinder (41) surface for a certain time,
the paper web of the certain grade is contacted with the heating cylinder surface various times, with various combinations of heating cylinder surface temperatures and dry content of the paper web,
information on whether the paper web is sticking on to the heating cylinder surface or not is kept on an electric memory,
a chart for a certain paper grade showing at which paper web dry contents and at which cylinder temperatures the paper web tends to stick on the cylinder is drawn up,
surface temperatures of drying cylinders (41) of a drying section (40) of a paper machine are selected based on the chart in such a way that according to the chart the paper web does not stick to the heated cylinder surfaces.

20. A method according to claim 14, characterised in that cylinder temperatures in the beginning of the drying section are selected to be higher than the temperatures at which the paper web is sticking to the heating cylinder surface.

21. Drying section (40) of a paper machine, which drying section comprises
a first steam group (45) of one or more steam heated rotating drying cylinders (41) each having a heated cylinder surface arranged to be contacted with a paper web in a predetermined order, the first group arranged in the beginning of the drying section,
a second steam group (46) of one or more steam heated rotating drying cylinders (41) each having a heated cylinder surface arranged to be contacted with a paper web in a predetermined order,
means for providing steam with substantially same pressure and temperature in cylinders of one group,
characterised in that the drying section (40) further comprises
means for providing the first steam group with steam of such pressure and temperature that cylinders (41) in the first steam group (45) are arranged to have a surface temperature of at least 120° C.,
means for conducting steam from the first steam group to the second steam group (46), and means for providing the steam at such pressure and temperature that cylinders in the second steam group are arranged to have a surface temperature substantially lower than in the first steam group.

22. A Drying section according to claim 21, characterised in that it comprises
a third steam group (47) of steam heated rotating drying cylinders each having a heated cylinder surface arranged to be contacted with a paper web in a predetermined order
means for conducting steam from the second steam group to the third steam group, and means for providing the steam at such pressure and temperature that cylinders in the third steam group are arranged to have a surface temperature substantially lower than in the second steam group.

23. A Drying section according to claim 21, characterised in that it comprises several steam groups (41-49) of steam heated rotating drying cylinders (41) and means for conducting steam from one steam group to another in such a way that every steam group is fed with steam with lower pressure compared to the previous steam group.
